(19) United States
(12) Patent Application Publication
(10) Pub. No.: US 2006/0268785 A1
(43) Pub. Date: Nov. 30, 2006

(54) Wireless communication system and method for preventing mutual interference between wireless communication channels

(75) Inventors: Jong-Ho Park, Yongin-si (KR); Hyun-Sik Shim, Yongin-si (KR); Jong-Chang Lee, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., Ltd.

(21) Appl. No.: 11/439,942

(22) Filed: May 24, 2006

(30) Foreign Application Priority Data
May 31, 2005 (KR) 2005-46280

(51) Int. Cl. H04Q 7/00

(52) U.S. Cl. 370/331

(57) ABSTRACT

Disclosed is a method for preventing mutual interference between wireless communication channels in a wireless communication system that includes at least one station, at least one AP connected to said at least one station, and a server. The method includes periodically checking by each AP wireless communication connection information on wireless communication setup with said at least one station; receiving by the server the wireless communication connection information from said at least one AP; analyzing by the server the received wireless communication connection information, determining if there exist an AP and stations connected to the AP, and generating a setup change message; transmitting by the server the generated setup change message to the AP and the stations; and receiving by the AP and the stations connected to the AP the setup change message, and changing the wireless communication setup based on the setup change message.

### PRIORITY

This application claims priority to an application entitled “Wireless Communication System And Method For Preventing Mutual Interference Between Wireless Communication Channels” filed in the Korean Intellectual Property Office on May 31, 2005 and assigned Serial No. 2005-46280, the contents of which are incorporated herein by reference.

### BACKGROUND OF THE INVENTION

1. Field of the Invention

The present invention relates to a wireless communication system for providing a wireless communication environment to stations such as a notebook computer, a Personal Digital Assistant (PDA), and a wireless control robot, and more particularly to a system and a method for preventing interference which may be caused by channels that stations use for wireless communication.

2. Description of the Related Art

Nowadays, a wireless communication environment using a wireless communication module such as a Wireless Local Area Network (WLAN) has been widely used, instead of a wired communication environment in which apparatuses (stations) with a communication function are directly connected to one another by means of a cable, etc. Such a wireless communication environment is achieved through both an apparatus with a communication function, i.e. stations with a wireless communication module, such as a notebook computer, a PDA, and a robot (e.g. a recent cleaning robot) which may be controlled in a wireless manner, and an Access Point (AP) which exchanges data with the at least one station through a preset wireless channel, and provides the data to a service provider [e.g. an Internet Service Provider (ISP)] for providing a network service, thereby enabling the stations to provide a network service such as an internet service. Such an AP has the same subscriber Identification (ID), and at least one AP may exist in the same single area. The subscriber ID represents an identifier uniquely assigned to each predetermined area.

FIG. 1 is a block diagram illustrating a conventional wireless communication system for providing a wireless communication environment. Referring to FIG. 1, two APs 100 and 106 exist within the same area, i.e. an area which may be regarded as the same area because it has one subscriber ID, and the two APs 100 and 106 are connected to two stations, respectively. Specifically, the AP 100 is connected to stations 102 and 104, and AP 106 is connected to stations 108 and 110. In such a case, APs 100 and 106 set wireless channels to be used for wireless communication with stations 102 and 104 and stations 108 and 110, respectively. Further, APs 100 and 106 select one of the wireless channels preset to be used for the wireless communication, and wirelessly exchange data with stations 102 and 104 and stations 108 and 110, respectively. For example, when each of APs 100 and 106 uses an Institute of Electrical and Electronics Engineers (IEEE) 802.11b standard, the channel preset to be used for the wireless communication may be one of 13 channels set at intervals of 5 MHz with respect to 2.4 GHz.

Herein, a WLAN scheme shows slight difference in each country, but an 802.11b/g system uses 13 channels spaced at intervals of 5 MHz in a frequency band of 2.4 GHz. Further, since it is generally allowed that each channel has widths of 22 MHz in the 802.11b and 20 MHz in the 802.11g system, the 802.11b/g system may have three non-overlapping channels, respectively. Accordingly, channel numbers 1, 6 and 11 in table 1 below correspond to the non-overlapping channels. Table 1 below shows an example of a central frequency for channels of the 802.11b system.

TABLE 1

| Channel number | Central frequency |
|---|---|
| 1 | 2412 |
| 2 | 2417 |
| 3 | 2422 |
| 4 | 2427 |
| 5 | 2432 |
| 6 | 2437 |
| 7 | 2442 |
| 8 | 2447 |
| 9 | 2452 |
| 10 | 2457 |
| 11 | 2462 |
| 12 | 2467 |
| 13 | 2472 |

As shown in table 1, if signal energy used by each channel does not deviate from 20 MHz (or 22 MHz) even during actual use, it may be possible to form a definition of anon-overlapping channel, but not in reality. FIGS. 2A, 2B and 2C are diagrams illustrating an example of interference of frequencies through a spectrum mask of such frequencies. FIGS. 2 A, 2B and 2C show an example of a spectrum mask of a frequency of a channel used in the 802.11b system. FIG. 2A shows a theoretical spectrum (power vs frequency) of a signal in the 802.11b system. Specifically, FIG. 2A shows that transmit power (dBr) in the middle of a channel decreases by 30 dB (1/1,000) at points spaced by 11 MHz left and right from the middle of the channel, and decreases by 50 dB (1/200,000) at points spaced by 22 MHz left and right from the middle of the channel.

Since the channels used in the 802.11b/g are spaced at intervals of 5 MHz, if two adjacent channels are used, the two adjacent channels overlap. FIG. 2B shows an example of the two adjacent channels. Referring to FIG. 2B, a portion 201 overlapping between the channel 1 and the channel 2 shows that power of the signal of the channel 2 overlaps with the main lobe (portion with the highest power) of the channel 1. Accordingly, as shown in FIG. 2B, since a considerable portion overlaps with the main lobe of the channel 2 and the main lobe of the channel 1, it is difficult to perform communication between the two channels. Therefore, interference occurs in communication between the two channels.

FIG. 2C shows another example of channels causing such interference. FIG. 2C shows a spectrum mask in which the channels with five channel intervals overlap with one another. However, since power of each signal is not exactly differentiated at a 22 MHz channel boundary, an overlapping portion exists even in the case of channels with predetermined channel intervals. In such a case, the power portion 202 of a channel 11 overlapping with the main lobe of a channel 6 is less than a maximum value of the channel 11 by minimum 30 dB (1/2,000). Further, since the overlapping power portion is small enough not to cause abnomality in the operation of each channel, the channels 6 and 11 can perform communication in spite of frequency interference therebetween. Hereinafter, a channel not affected by the interference will be referred to as a non-overlapping channel. Further, a channel within the range in which communication may be affected by such frequency interference will be referred to as an adjacent channel. Accordingly, in order to prevent the channels from being affected by the frequency interference, it is necessary to set the channels as non-overlapping channels in which frequencies used by the channels maintain predetermined distances not causing interference.

In a general wireless communication system, at least one AP may exist in a single area as illustrated in FIG. 1. This is because the number of stations to which one AP can provide a wireless communication environment is restricted. Accordingly, there may exist one or more APs with an ID uniquely assigned to each same area. In such a case, the APs may use channels for communication with the stations connected to each of the APs, which may cause interference because they are the same or adjacent channels. That is, when the AP 100 uses a wireless communication channel 1 for communication with stations 102 and 104, AP 106 may select and set either the wireless communication channel 1 or one of wireless communication channels 2 to 4 which are adjacent to the wireless communication channel 1 when setting a channel for communication with stations 108 and 110.

In such a case, the channel through which the APs communicate with the stations may cause interference between the wireless communication channels. The interference between the wireless communication channels represents interference between frequencies occurring when frequencies used by each communication channel are not sufficiently spaced apart, i.e. a phenomenon which causes the occurrence of a data reception error, the reduction of a bandwidth, the reduction of a Received Signal Strength Indicator (RSSI), etc. Therefore, in the case of the conventional wireless communication system, due to the occurrence of the mutual interference between the wireless communication channels, a data reception error may occur, a bandwidth may be reduced, a RSSI may be reduced, etc.

### SUMMARY OF THE INVENTION

Accordingly, the present invention has been made to solve the above-mentioned problems occurring in the prior art, and an object of the present invention is to provide a system and a method for wireless communication, which can provide wireless communication apparatuses with a wireless environment in which interference between wireless communication channels is minimized.

In accordance with one aspect of the present invention, there is provided a wireless communication system that includes at least one station with a wireless communication function; at least one Access Point (AP) for periodically checking wireless environment information about a wireless communication environment with the stations, said at least one AP being connected to said at least one station; and a server for receiving the wireless environment information from said at least one AP, selecting an AP and stations connected to the AP, which are to change the wireless communication environment, based on the received wireless environment information, and controlling setting of the wireless communication environment of the AP and the stations to be altered.

In accordance with another aspect of the present invention, there is provided a wireless communication method for preventing mutual interference between wireless communication channels in a wireless communication system including at least one station with a wireless communication function, at least one Access Point (AP) which shares a subscriber identification and is wirelessly connected to said at least one station, and a server to which said at least one AP is connected, the wireless communication method includes periodically checking by each AP wireless communication connection information on wireless communication setup with said at least one station; receiving by the server the wireless communication connection information from said at least one AP; analyzing by the server the received wireless communication connection information, determining if there exist an AP and stations connected to the AP, which are to alter the wireless communication setup, and generating a setup change message including change content of the wireless communication setup of the AP and the stations connected to the AP, which are to change the wireless communication setup; transmitting by the server the generated setup change message to the AP and the stations connected to the AP, which are to change the wireless communication setup; and receiving by the AP and the stations connected to the AP the setup change message, and changing the wireless communication setup based on the setup change message.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a conventional wireless communication system for providing stations with a wireless communication environment;

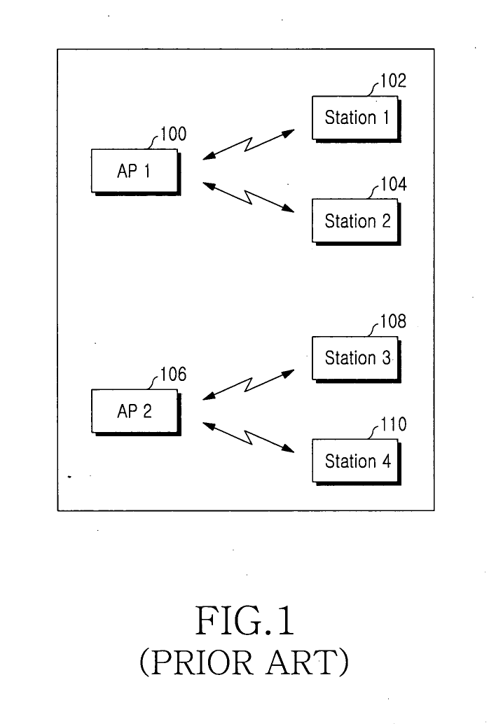

FIGS. 2A, 2B and 2C are diagrams illustrating a spectrum mask of a frequency of a channel used in an 802.11b system;

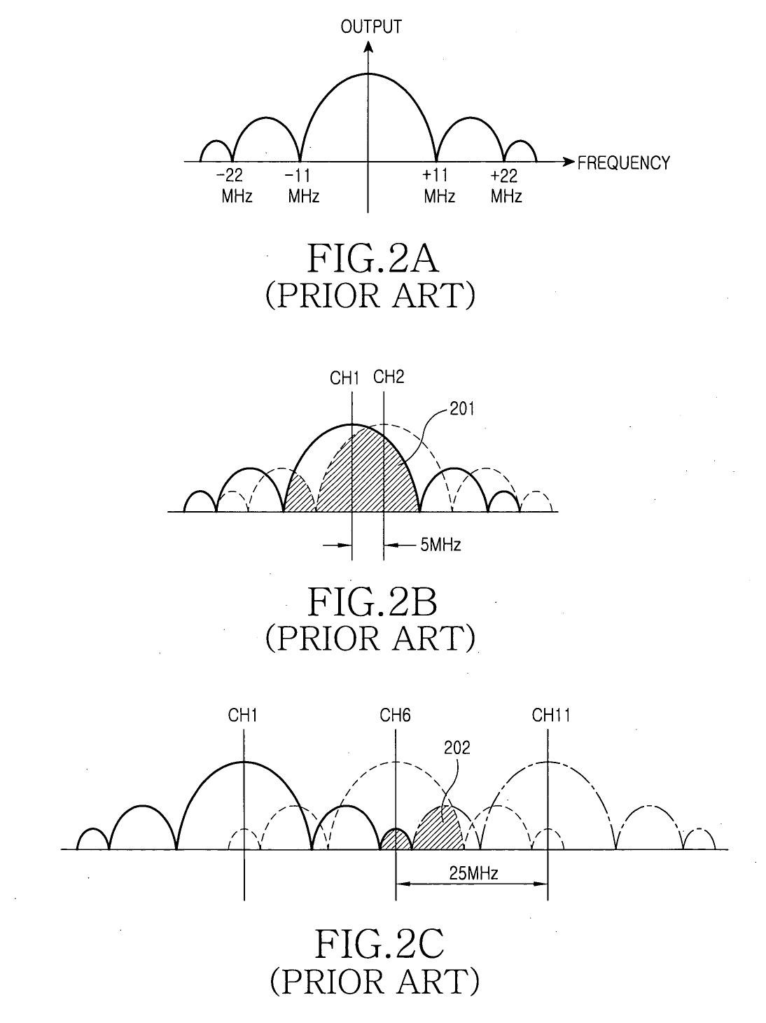

FIG. 3 is a block diagram illustrating the construction of a wireless communication system for providing stations with a wireless communication environment according to the present invention;

FIG. 4 is a flow diagram illustrating a process for changing a channel of a specific AP and stations when channel interference may occur in a wireless communication system according to the present invention;

FIG. 5 is a flow diagram illustrating a process in which a server of a wireless communication system according to the present invention changes a channel which may occur channel interference; and

FIG. 6 is a flow diagram illustrating a process for increasing transmit power of a wireless communication channel between an AP and stations selected in order to perform channel change when there is no channel currently not in use outside of an interference range which may occur interference.

### DETAILED DESCRIPTION OF THE PREFERRED EMBODIMENT

A preferred embodiment of the present invention will be described in detail herein below with reference to the accompanying drawings. It should be noted that the similar components are designated by similar reference numerals although they are illustrated in different drawings. Also, in the following description, a detailed description of known functions and configurations incorporated herein will be omitted when it may obscure the subject matter of the present invention.

For aiding with the complete understanding of the present invention, the basic principle of the present invention will be described. In the present invention, when one or more APs exist in the same area, information on wireless communication connection states of the APs is periodically provided, so that it is possible to understand the wireless communication channels, which are used by each of the APs for wireless communication with stations, based on the information on wireless communication connection states. Further, when the APs currently perform wireless communication with the stations through the same channel or an adjacent channel, at least one AP intended for a change of the wireless communication channel can be selected from the APs using the same channel or the adjacent channel, the channel of the selected AP can be altered to a different channel other than the adjacent channel. The adjacent channel represents channels within the range of a bandwidth in which mutual interference between wireless communication channels may occur. For example, when the APs use an IEEE 802.11b system and the range of the bandwidth in which mutual interference may occur is 20 MHz, the altered channel must be a channel spaced more than five channels away from a channel currently used by another AP.

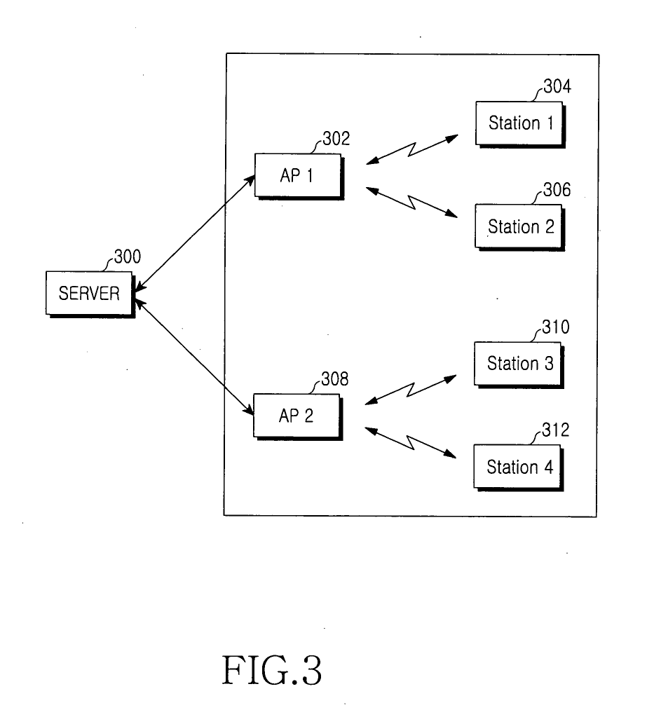

FIG. 3 is a block diagram illustrating the construction of a wireless communication system according to the present invention. Referring to FIG. 3, the wireless communication system includes stations 304, 306, 310 and 312 with wireless communication functions, APs 302 and 308 for providing a wireless communication environment to the stations 304, 306, 310 and 312, and a server 300. The server 300 receives information (wireless communication connection information) on wireless communication connection states from the APs 302 and 308 and the stations 304, 306, 310 and 312. The server 300 checks if each of the APs 302 and 308 currently existing in the same area use the same channel or an adjacent channel through the received wireless communication connection information.

In the wireless communication system according to the present invention, when the APs 302 and 308 are powered on, the APs 302 and 308 connect to the server 300, and check if a report period of the wireless communication connection information to the server 300 has expired. When the report period has expired, the AP 302 requests the stations 304 and 306 to transmit wireless connection information used in order to check the current wireless communication states with the stations 304 and 306, and the AP 308 requests the stations 310 and 312 to transmit wireless connection information used in order to check the current wireless communication states with the stations 310 and 312. After receiving the wireless connection information from the stations 304, 306, 310 and 312, each of the APs 302 and 308 generates wireless communication connection information in order to inform the server 300 of its own wireless communication connection state, and transmits the generated wireless communication connection information to the server 300. Table 2 below shows an example of the wireless communication connection information provided from the APs 302 and 308 and the stations 304, 306, 310 and 312 to the server 300.

TABLE 2

| Subscriber | IP | Service | | Data | Device | Connection | WLAN | Setup | TX |
|---|---|---|---|---|---|---|---|---|---|
| ID | address | ID | ESSID | speed | type | mode | type | channel | power |
| Specific | IP | Wireless | Specific | 1M:0 | AP:0 | Adhoc:0 | 11a:0 | Currently | Current |
| area ID | address | communication | AP ID | 2M:1 | Station:1 | Infra:1 | 11b:1 | set | transmit |
| | of AP or | service | | 5M:2 | | | 11g:2 | channel | power |
| | station | ID | | 11M:3 | | | | number | intensity |
| | connected | | | 22M:4 | | | | | |
| | to | | | 54M:5 | | | | | |
| | the AP | | | | | | | | |

Referring to Table 2, the subscriber ID includes specific ID information about an area in which the APs are located, and the IP address includes IP address information of the AP or the station, which transmits wireless communication connection information to the server 300. When the server 300 can provide a different function in addition to a management function for a wireless communication service, e.g. when the server 300 can provide the stations 304, 306, 310 and 312 with a function for an image service such as a Video On Demand (VOD), the service ID represents an ID for identifying the type of the currently provided service like this. The ESSID represents specific IDs of the APs 302 and 308, and the device type is for identifying if a generator of the wireless communication connection information is an AP or a station. The WLAN type is information for reporting if the currently used wireless communication scheme is based on an IEEE 802.11a, an IEEE 802.11b or an IEEE 802.11g standard.

As shown in Table 2, the wireless communication connection information includes information about an area in which the APs and the stations are currently located, information about the currently set communication channels, identification information of each AP, and information about different device types, etc., in the case of an AP and a station. According to the present invention, when the wireless communication connection information is received from the APs 302 and 308, the server 300 can check how many APs are located in the same area, what channels are used by the APs, and if the APs use the same channel or an adjacent channel which may cause interference. Table 3 below shows an example of a wireless environment database generated based on the wireless communication connection information received from a plurality of APs and stations.

TABLE 3

| | Subscriber | IP | Service | | Data | Device | Connection | WLAN | Setup | TX |
|---|---|---|---|---|---|---|---|---|---|---|
| No | ID | address | ID | ESSID | speed | type | mode | type | channel | power |
| 1 | 0001 | 310.222.199.180 | 0001 | AP1 | 3 | 0 | 1 | 1 | 1 | 20 |
| 2 | 0001 | 310.222.199.181 | 0001 | AP1 | 3 | 1 | 1 | 1 | 1 | 20 |
| 3 | 0001 | 310.222.199.190 | 0001 | AP2 | 3 | 0 | 1 | 1 | I | 20 |
| 4 | 0001 | 310.222.199.191 | 0001 | AP2 | 3 | 1 | 1 | 1 | 1 | 20 |
| 5 | 0001 | 310.222.199.192 | 0001 | AP2 | 3 | 1 | 1 | 1 | 1 | 20 |
| 6 | 0002 | 310.222.199.300 | 0001 | AP3 | 3 | 0 | 1 | 1 | 1 | 20 |
| 7 | 0002 | 310.222.199.201 | 0001 | AP3 | 3 | 1 | 1 | 1 | 1 | 20 |

Referring to Table 3, it can be understood that two APs with the specific IDs (AP1 and AP2) exist in a single area, one station with the IP address of 310.222.199.181 is connected to the AP with the ESSID of the AP1, and two stations with the IP addresses of 310.222.199.191 and 310.222.199.192 are connected to the AP with the ESSID of the AP2. In addition, the server 300 can become aware of the fact that the APs located in the single area commonly use a channel 1 through the received wireless communication connection information. If the server 300 becomes aware of the fact that the APs use the same channel or the adjacent channel which may cause interference, the server 300 of the wireless communication system according to the present invention selects one of the two APs. Further, the server 300 selects one of both channels, which are currently used by the selected AP and the stations connected to the selected AP, and channels outside of the range of the channel which may cause the interference. Then, the server 300 generates a channel change message indicating the change to the selected AP of a wireless communication channel, and transmits the generated message to the selected AP and the stations connected to the selected AP. Table 4 below shows an example of such a channel change message. As a result of checking the wireless communication states through Table 3, even when there is no abnormality in the channel, if it is necessary to change transmit power or to change a data rate in wireless communication, the server 300 inserts this content into the channel change message and transmitting the channel change message, thereby controlling the wireless communication states of the AP and the stations connected to the AP.

TABLE 4

| | | | | | | | Power | Data rate |
|---|---|---|---|---|---|---|---|---|
| | Service | | Device | Connection | WLAN | Change | change | change |
| IP address | ID | ESSID | type | mode | type | channel | value | value |
| IP address | Wireless | Specific | AP:0 | Adhoc:0 | 11a:0 | Number | Intensity | Data rate to |
| of AP or | communication | AP ID | Station:1 | Infra:1 | 11b:1 | of channel | of | be changed |
| station | service | | | | 11g:2 | to be | transmit | |
| connected | ID | | | | | changed | power to | |
| to the AP | | | | | | | be | |
| | | | | | | | changed | |

As shown in Table 4, if the channel change message is received, the AP and the stations perform channel change to a channel number to be changed, which is included in the channel change message. If a change value of power intensity or a change value of a data rate is included in the channel change message, the AP and the stations readjust the wireless communication states based on such a change value. Accordingly, in the present invention, it is possible to prevent mutual interference between wireless communication due to the use of the same channel or an adjacent channel. Further, in the wireless communication system according to the present invention, the server directly transmits a change message for channel change and wireless communication state readjustment to the stations as well as to the AP, thereby minimizing time required for channel change of the stations and directly controlling the stations.

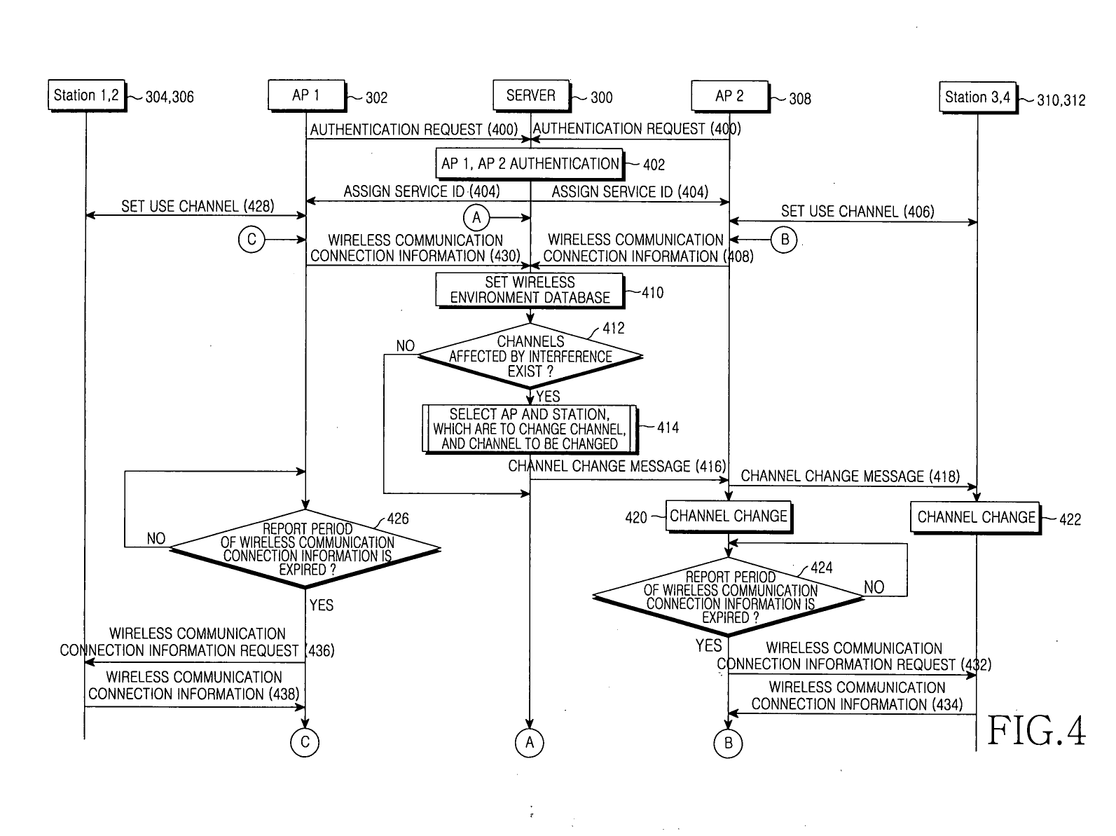

FIG. 4 is a flow diagram illustrating a process in which a server receives wireless communication connection information from one or more APs, and changes wireless communication channels used by APs and stations, which must perform channel change, in a wireless communication system according to the present invention. In FIG. 4, for convenience of description, the wireless communication system, which includes the stations 304, 306, 310 and 312, the APs 302 and 308, and the server 300 in FIG. 3, is used as an example.

Referring to FIG. 4, if the APs 302 and 308 are powered on, the APs 302 and 308 transmit to the server 300 authentication requests for a service, which is to be provided to the stations 304, 306, 310 and 312, in step 400. If the authentication requests are received from the APs 302 and 308, the server 300 perform authentication for the APs 302 and 308 in step 402. If the authentication by the server 300 is terminated in step 402, the APs 302 and 308 become connected to the server 300.

In step 404, the server 300 assigns service IDs, which are used for receiving the requested service, to the APs 302 and 308 in response to the service request in step 400. In step 428, the AP 302 determines if communication channel connection setup requests are received from the stations 304 and 306. If the communication channel connection setup requests are received, the AP 302 sets a channel to be used for wireless communication with the stations 304 and 306. After setting the channel to be used for wireless communication with the stations 304 and 306, the AP 302 provides the server 300 with the wireless communication connection information as shown in Table 2 in step 430.

In step 406, the AP 308 determines if communication channel connection setup requests are received from the stations 310 and 312. If the communication channel connection setup requests are received, the AP 308 sets a channel to be used for wireless communication with the stations 310 and 312. After setting the channel to be used for wireless communication with the stations 310 and 312, the AP 308 provides the server 300 with the wireless communication connection information as shown in Table 2 in step 408.

After receiving the wireless communication connection information from the AP 302 and the AP 308, the server 300 generates the wireless environment database as shown in Table 3 by means of the received wireless communication connection information in step 410. In step 412, the server 300 checks the wireless communication connection information stored in the wireless environment database, and checks the wireless communication states of both APs, which currently exist in the same area, and stations connected to each of the APs. Further, the server 300 determines if mutual interference has occurred between the communication channels used by the APs. The determination regarding whether the mutual interference has occurred may include determining if the wireless communication channels used by the APs and the stations overlap with one another, if the APs and the stations use channels within the range of an adjacent channel which may cause the mutual interference.

In step 412, if the wireless communication channels used for wireless communication of both the APs, which exist in the same area, and the stations connected to each of the APs, are equal to one another, or if the wireless communication channels are sufficiently spaced to the extent that they do not cause the mutual interference, the process returns to step 410. That is, the server 300 receives the wireless communication connection information from the AP 302 and the AP 308, and generates the wireless environment database as shown in Table 3 by means of the received wireless communication connection information.

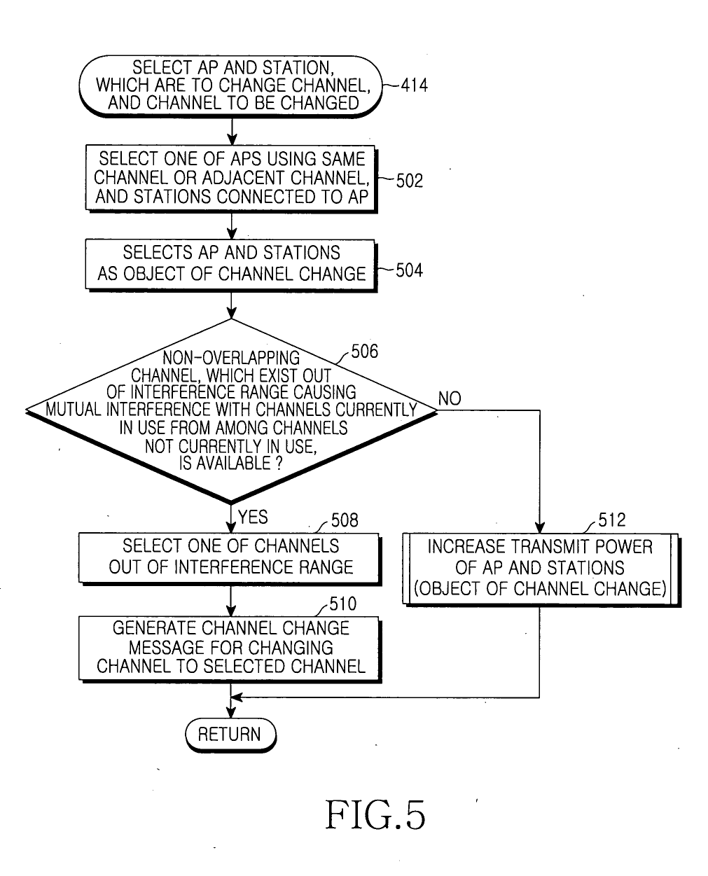

However, if a channel affected by the mutual interference exits in the wireless communication channels used for wireless communication with the APs and the stations connected to each of the APs in step 412, step 414 is performed. That is, the server 300 selects both an AP intended for change of a channel and the stations connected to the AP, and selects a channel to be used by the selected channel and the stations. Herein, the server 300 may select a channel outside of the range of the adjacent channel from among channels which are not used in an area in which the selected AP currently exists. If the channels outside of the range of the adjacent channel are currently in use, it is possible to increase the transmit power of the AP and the stations which have been selected for the channel change. Step 414 will be described in detail with reference to FIG. 5.

After the server 300 selects the AP and the stations, which are to perform a channel change, and the channel to be used by the selected channel and the stations in step 414, the server 300 transmits a channel change message to the selected channel and stations in step 416. Step 416 in FIG. 4 exemplifies a case in which the server 300 selects the AP 308 and the stations 310 and 312 connected to the AP 308 as the AP and the stations which have been selected for the channel change, respectively. In such a case, the channel change message generated by the server 300 is transmitted to the AP 308. In step 418, the AP 308 transmits the received channel change message to the stations 310 and 312. In step 420, the AP 308 changes the existing channel to the channel included in the channel change message. In step 422, each of the stations 310 and 312 changes the existing channel to the channel included in the channel change message. In step 424, the AP 308 determines if the report period of the preset wireless communication connection information has expired. When the report period has expired, the AP 308 transmits a wireless communication connection information request to the stations 310 and 312 in step 432. After receiving the wireless communication connection information request, each of the stations 310 and 312 provides the AP 308 with wireless communication connection information including a channel change result in response to the request in step 434. Then, step 408 is performed. That is, the AP 308 provides the server 300 with both the wireless communication connection information received from the stations 310 and 312 and its own wireless communication connection information.

In the wireless communication system according to the present invention, an AP, which does not receive the channel change message, determines only if the report period of the wireless communication connection information has expired. Hereinafter, a case in which the AP 302 and the stations 304 and 306 connected to the AP 302 are not selected as the AP and the stations which are selected for the channel change will be described. The AP 302 determines if the report period of the preset wireless communication connection information has expired in step 426 before receiving the channel change message from the server 300. When the report period has expired in step 426, the AP 302 transmits a wireless communication connection information request to the stations 304 and 306 in step 436. After receiving the wireless communication connection information request, each of the stations 304 and 306 provides the AP 302 with current wireless communication connection information in response to the request in step 438. Then, step 430 is performed. That is, the AP 302 provides the server 300 with both the wireless communication connection information received from the stations 304 and 306 and its own wireless communication connection information. Accordingly, in the wireless communication system according to the present invention, it is possible to prevent the mutual interference between wireless communication channels from occurring due to the use of the same channel or are adjacent channel. Further, the server directly transmits the change message for the channel change and the wireless communication state readjustment, thereby minimizing time required for channel change of the stations.

FIG. 5 is a flow diagram illustrating in detail step 414 in FIG. 4. That is, FIG. 5 illustrates a process in which the server of the wireless communication system according to the present invention selects an AP using the same channel or are adjacent channel, and stations connected to the selected AP in order to change the channel which may cause the channel interference, and changes the channel used by the selected AP and stations. Referring to FIG. 5, if the server 300 becomes aware of the fact that there is a channel affected by interference due to the use of the same channel or the adjacent channel, based on the wireless environment database in step 412 of FIG. 4, the server 300 selects wireless communication connection information of an AP using the same channel or an adjacent channel, and the stations connected to the selected AP in step 502. In step 504, the server 300 selects the AP and the stations, which are selected in step 502, as objects which must perform the channel change.

In step 506, the server 300 determines if a non-overlapping channel, which exists outside of the interference range causing mutual interference with channels currently in use from among channels not currently in use, is available. For example, it is assumed that the AP 302 and the stations 304 and 306 connected to the AP 308 commonly use a channel 8, and the AP 308 and the stations 310 and 312 connected to the AP 308 commonly use a channel 7. In such a case, it is assumed that the range of an adjacent channel causing the mutual interference is 20 MHz and an interval between channels is 5 MHz. If the server 300 selects the AP 308 and the stations 310 and 312 in step 502, the server 300 determines if an available channel exists in channels spaced more than 100 MHz from the channel 8, which is used by the AP 302, i.e. channels spaced more than five channels. That is, the server 300 checks for an available channel of a channel 13 spaced more than five channels from the channel 8, and channels 1 to 3.

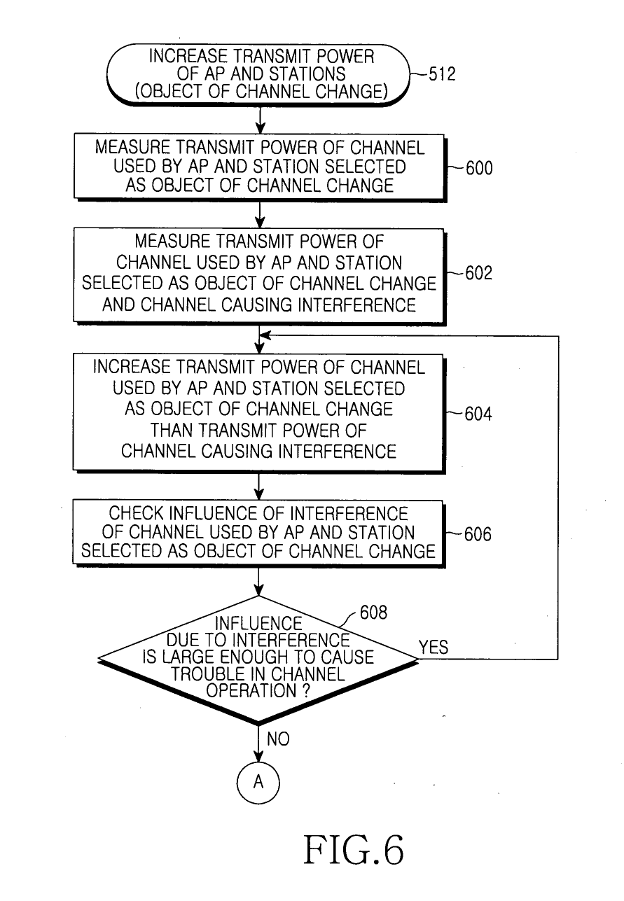

Herein, the server 300 may also check if the available channel exists according to a priority preset between channels, e.g. a preset priority based on a sequence in which a channel with a high number precedes a channel with a lower number or a sequence in which a channel with a lower number precedes a channel with a high number. If there is no available channel from among the spaced channels according to the priority in step 506, the server 300 becomes aware of the fact that available extra channels do not currently exist. Then, in step 512, the server 300 increases transmit power of communication channels currently used by the AP and stations which have been selected for the channel change. Step 512 will be described in detail with reference to FIG. 6.

However, if the extra channels exist in step 506, the server 300 determines if non-overlapping channels exist in the extra channels in step 508. If the non-overlapping channels exist, the server 300 selects one of the non-overlapping channels. Herein, the server 300 may use a preset sequence, i.e. a method for preferentially selecting a channel with a low number or a channel with the highest number from the non-overlapping channels, in order to improve efficiency of use of a channel. In step 510, the server 300 generates a channel change message indicating that the AP and the stations selected in step 502 must perform channel change to the selected non-overlapping channel. Then, step 416 is performed. That is, the server 300 transmits the generated channel change message to the corresponding AP and the stations.

FIG. 6 is a flow diagram illustrating an operation for reducing influence of the interference by increasing transmit power of a wireless communication channel of the AP and the stations, which are selected in order to perform the channel change in step 504, when channels currently not in use do not exist outside of the interference range causing mutual interference in step 512. Referring to FIG. 6, when all of the channels currently not in use exist within the interference range causing the mutual interference as a result of the check in step 504, the server 300 measures the transmit power of the wireless communication channel used by the AP and the stations currently selected in order to perform the channel change, in step 600. In step 602, the server 300 checks the transmit power of both the wireless communication channel used by the AP and the stations and a channel which currently causes interference.

In step 604, the server 300 increases the transmit power of both the wireless communication channel used by the AP and the stations, which are selected in order to perform the channel change, rather than the transmit power of the channel which causes the interference. It is therefore possible to transmit the wireless communication channel used by the AP and the stations at a transmit power greater than the transmit power of the channel causing the mutual interference, which in turn minimizes the mutual interference.

That is, the transmit power of the channel causing the mutual interference is used as a reference to increase the transmit power of the channel currently selected for channel change in order to minimize the mutual interference when the channel change is not possible.

Herein, the server 300 may increase the transmit power of the wireless communication channel by a preset value. In step 606, the server 300 checks the influence of the interference which the wireless communication channel used by the AP and the stations currently selected in order to perform the channel change suffers from due to the channel causing the interference. Herein, the server 300 may check the influence of the interference by means of various methods. For example, the server 300 may transmit test signals for a predetermined time period, receive the test signals, and check reception results of the test signals. Further, the server 300 may check the degree of overlap between the channels.

In step 608, the server 300 determines if the influence of the interference is great enough to cause trouble in a channel operation. In determining if the influence of the interference is great enough to cause trouble in the channel operation, the server 300 may also determine that the influence is great enough to cause trouble in the channel operation either when the result value in step 606 is less than or greater than a preset value, or according to an actual operation based on signals and degree of signal reception. If the influence of the interference is great enough to cause trouble in the channel operation, the server 300 increases the intensity of transmit power of the wireless communication channel used by the AP and the stations selected in order to perform the channel change, in step 604. Further, the server 300 determines if the influence of the interference is great enough to cause trouble in an operation of the wireless communication channel used by the AP and the stations selected in order to perform the channel change, through steps 606, 608 and 610.

However, if the influence of the interference is not great enough to cause trouble in the channel operation, the server 300 receives the wireless communication connection information from the AP 302 and the AP 308, and sets the wireless environment database of step 410. Accordingly, in the present invention, an available wireless communication channel not causing interference is determined according to a preset priority. As a result of the determination, if there is no available wireless communication channel, transmit power of one of the wireless communication channels causing influence is increased, so that it is possible to reduce influence of the interference.

According to the present invention as described above, when one or more APs exist in the same area, information on the wireless communication connection states of the APs is periodically provided, so that it is possible to understand wireless communication channels used for wireless communication between each of the APs and stations. When the APs perform wireless communication through the same channel or an adjacent channel, at least one AP intended for change of a wireless communication channel is selected from the APs using the same channel or the adjacent channel, the channel of the selected AP can be changed to a channel other than the adjacent channel. Consequently, it is possible to prevent mutual interference between wireless communication channels from occurring due to the same channel or an adjacent channel. Further, a server directly transmits a change message for channel change and wireless communication state readjustment, thereby minimizing time required for channel change of the stations.

Although a preferred embodiment of the present invention has been described for illustrative purposes, those skilled in the art will appreciate that various modifications, additions and substitutions are possible, without departing from the scope and spirit of the invention as disclosed in the accompanying claims, including the full scope of equivalents thereof. That is, in an embodiment of the present invention, an AP receives a channel change message, and communication channels of the AP and stations connected to the AP are altered. However, the channel change message may also be transmitted to another AP. In such a case, communication channels of said another AP and stations connected to said another AP may also be altered.

What is claimed is:

1. A wireless communication system, comprising:
at least one station with a wireless communication function;
at least one access point (AP) for periodically checking wireless environment information about a wireless communication environment with the at least one station, said at least one AP being connected to said at least one station; and
a server for receiving the wireless environment information from said at least one AP, selecting an AP and stations connected to the AP, which change the wireless communication environment, based on the received wireless environment information, and controlling a setting of the wireless communication environment of the AP and the stations to be altered.

2. The wireless communication system as claimed in claim 1, wherein, when the server recognizes the possibility of an occurrence of a mutual interference in a wireless communication channel, which is used for wireless communication between said at least one AP and the stations connected to each AP, based on the received wireless environment information, the server controls one of said at least one AP and the stations connected to the AP, and changes the wireless communication channel between the AP and the stations.

3. The wireless communication system as claimed in claim 2, wherein the server changes the wireless communication channel between one of said at least one AP, which may cause the mutual interference, and the stations connected to the AP according to a preset priority between wireless communication channels.

4. The wireless communication system as claimed in claim 3, wherein, when all alterable wireless communication channels have a possibility of causing the mutual interference during a change of the wireless communication channel, the server increases transmit power of the wireless communication channel between the AP and the stations connected to the AP, which are selected for the change of the wireless communication channel.

5. The wireless communication system as claimed in claim 1, wherein the server corresponds to a server used in a Ubiquitous Robot Companion (URC) environment.

6. The wireless communication system as claimed in claim 5, wherein the station corresponds to a station used in the URC environment.

7. A wireless communication method for preventing mutual interference between wireless communication channels in a wireless communication system including at least one station with a wireless communication function, at least one access point (AP) which shares a subscriber identification and is wirelessly connected to said at least one station, and a server to which said at least one AP is connected, the wireless communication method comprising the steps of:
periodically checking by each AP wireless communication connection information on wireless communication setup with said at least one station;
receiving by the server the wireless communication connection information from said at least one AP;
analyzing by the server the received wireless communication connection information, determining if there exist an AP and stations connected to the AP, which are to alter the wireless communication setup, and generating a setup change message including change content of the wireless communication setup of the AP and the stations connected to the AP, which change the wireless communication setup;
transmitting by the server the generated setup change message to the AP and the stations connected to the AP, which change the wireless communication setup; and
receiving by the AP and the stations connected to the AP the setup change message, and changing the wireless communication setup based on the setup change message.

8. The wireless communication method as claimed in claim 7, wherein the step of generating the setup change message comprises:
when there exist APs using an overlapping wireless communication channel determined as a result of analyzing the wireless communication connection information, selecting by the server one of the APs using the overlapping wireless communication channel and stations connected to the AP, in order to perform channel change;
selecting by the server one of channels currently not in use; and
generating by the server the setup change message indicating a change to the selected channel of a wireless communication channel between the selected AP and the stations connected to the selected AP.

9. The wireless communication method as claimed in claim 7, wherein the step of generating the setup change message comprises:
when there exist APs using a wireless communication channel within a range of an adjacent channel having a possibility of causing mutual interference determined as a result of analyzing the wireless communication connection information, selecting by the server one of the APs using the overlapping wireless communication channel and stations connected to the AP as objects of a channel change;
selecting by the server a channel currently not in use; and
generating by the server the setup change message indicating change to the selected channel of a wireless communication channel between the selected AP and the stations connected to the selected AP.

10. The wireless communication method as claimed in claim 8, wherein the step of selecting the channel comprises:
selecting by the server a wireless communication channel currently not in use; and
selecting by the server an unused channel from overlapping channels outside of the range of the adjacent channel having a possibility of causing the mutual interference with channels currently in use.

11. The wireless communication method as claimed in claim 9, wherein the step of selecting the channel comprises:
selecting by the server a wireless communication channel currently not in use; and
selecting by the server an unused channel from overlapping channels outside of the range of the adjacent channel having a possibility of causing the mutual interference with channels currently in use.

12. The wireless communication method as claimed in claim 10, wherein, in the step of selecting the unused channel, the server selects one of the unused overlapping channels based on a preset priority.

13. The wireless communication method as claimed in claim 7, wherein the step of generating the setup change message comprises:
when there exist APs using a wireless communication channel having a possibility of causing mutual interference determined as a result of analyzing the wireless communication connection information, selecting by the server one of the APs and stations connected to the AP;
searching by the server if there exists an available channel of non-overlapping channels which do not cause mutual interference in a wireless communication channel between the selected AP and the stations connected to the selected AP; and
when there is no available non-overlapping channel determined as a result of the search, generating by the server the setup change message indicating an increase in transmit power of the selected AP and stations.
